(19) United States
(12) Patent Application Publication
(10) Pub. No.: US 2009/0160416 A1
(43) Pub. Date: Jun. 25, 2009

(54) DC-DC CONVERTER

(75) Inventors: Norihiro Kawagishi, Tokyo (JP); Yuichi Okubo, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/333,450

(22) Filed: Dec. 12, 2008

(30) Foreign Application Priority Data
Dec. 20, 2007 (JP) 2007328558

(51) Int. Cl. G05F 1/46

(52) U.S. Cl. 323/288

(57) ABSTRACT

A DC-DC converter generates an optimal slope compensation voltage in response to input and output voltages, thus capable of maintaining its operational stability even when a dynamic range of the output voltage is widen. The DC-DC converter compares an error voltage corresponding to a difference between a feedback voltage of the output voltage and a reference voltage with a ramp signal whose voltage level corresponds to a current detection signal, so as to configure an off-timing of an output transistor. A slope of the ramp signal is configured so that the ramp signal is proportional to a difference between the output voltage and the input voltage. A slope compensation circuit for generating the ramp signal includes an adding circuit for generating a slope controlling electric current corresponding to a voltage in which a voltage corresponding to the input voltage is subtracted from a voltage corresponding to the output voltage, and a capacitor electrically charged with the slope controlling current.

### BACKGROUND OF THE INVENTION

1. Field of the Invention

The present invention relates to a DC-DC converter and, in particular, relates to a DC-DC converter including a slope compensation circuit.

2. Description of the Related Art

Controls of a switching DC-DC converter are mainly classified into a voltage mode control and a current mode control. In the voltage mode control, an output voltage is partially feed-backed to a control signal so as to control a duty ratio in switching a power switch, and thus the output voltage is stabilized. In the current mode control, electric current changes of a coil are also used for controlling the duty ratio. The current mode control is advantageous in that it is respective to response to variations of a load is quicker than the voltage mode control and its load regulation is superior to the voltage mode control, so that a responsiveness to the input voltage changes or turbulences of the former is quicker than the latter, thereby to provide a superior input regulation. In such a current mode controlled DC-DC converter, it is known that an energization period of a coil electric current reaching 50% of a clock cycle results in a sub-harmonic phenomenon in which a control operation is unstable. In the current mode controlled DC-DC converter, a ramp signal with a constant slope for controlling an output transistor at a duty ratio, is generated by a slope compensation circuit so as to suppress such an unstable operation. Moreover, in a circuit system changeable of an output voltage of a DC-DC converter according to applications, a system is known for changing a slope of the ramp signal depending on an output voltage of the converter so as to stably operate the converter within a range of a total output voltage.

A document D1 (Japanese Patent Kokai No. 2007-209103) discloses a current mode controlled DC-DC converter including a slope compensation circuit. The DC-DC converter is provided with an external input terminal. An output voltage of the converter is changed in dependence upon a voltage value of an external control voltage V_{PABAIAS} applied to the external input terminal PABIAS. In addition, a slop of a slope compensation voltage is changed in dependence upon a value of the external control voltage V_{PABAIAS}. That is, in response to an increase in the external control voltage V_{PABAIAS} applied via the external input terminal, a current signal I_{PABAIAS} proportional to the external control voltage V_{PABAIAS} is increased. A transistor M11 for flowing a mirror electric current of the current signal I_{PABAIAS} operates so as to reduce an electric current for charging a condenser C2 by which the slope of the slope compensation voltage is determined, thus resulting in a decrease in the slope of the slope compensation voltage. In contrast, a decrease in the external voltage V_{PABAIAS} results in an increase in the slope of the slope compensation voltage. In this way, the slope of the slope compensation voltage is changed in dependent upon a voltage level of the external control voltage V_{PABAIAS} supplied via the external input terminal, so that an appropriate slope compensation voltage is consistently generated by changing the slope of the slope compensation voltage even in a case of wide dynamic range of the output voltage. In such a manner, a power circuit can be stabilized.

However, the slope of the slope compensation voltage (ramp signal) is changed in proportion to the output voltage of the converter in the case of the circuit system described in the document D1. An appropriate slope compensation voltage can be obtained by a converter of the step-down converter, but there was such an inconvenience that the circuit system of the document D1 can not be applied to a step-up converter. That is, in case of a step-up DC-DC converter, the coil electric current increases with a constant slope in similar with the step-down DC-DC converter during the output transistor is turned on, and the slope of the coil electric current IL is proportional to the input voltage. In case of a step-up DC-DC converter which behaves in a different way from the step-down DC-DC converter, the coil electric current decreases with a constant slope when the output transistor is turned off. The slope of the coil electric current IL in this case is proportional to a difference between the output and input voltages. If, specifically, the difference between the output voltage and input voltage is relatively large, the slope of the decreasing coil electric current IL becomes comparatively gradual, so that the energizing time period of the coil is prolonged. If, on the other hand, a difference between the output voltage and input voltage is relatively small, the slope of the decreasing coil electric current IL increases to be comparatively steeper, so that the energizing time period of the coil is shortened. In order to prevent the sub-harmonic phenomenon described above, a time period (energizing period) between when the output transistor is turned off and when the coil electric current IL decreases completely is required to be equal to or less than 50% of the clock cycle. Therefore, in a step-up converter where the time changes in dependence upon the difference between the output and input voltages, it is necessary to change the slope of the slope compensation voltage depending upon the difference between the output and input voltages.

Moreover, the above conventional circuit system is required to include an input terminal for configuring the output voltage from the outside. When the above conventional circuit system is applied to a general circuit system where the output voltage is configured by a division voltage ratio of the division resistances provided outside, there is such an inconvenience that it is necessary to provide an additional terminal, too.

The present invention is provided in a view of the above problems. The present invention aims to provide a DC-DC converter for automatically generating an optimal slope compensation voltage in response to input and output voltages so as to maintain an operational stability even when the dynamic range of the output voltage is widen.

According to an aspect of the present invention, there is provided a DC-DC converter comprising: a switching circuit connected to an inductor connected between input and output terminals, for turning on/off an electric current flowing to the inductor in response to a driving signal; a driving signal supply circuit for supplying the driving signal to the switching circuit; a ramp signal generation circuit for generating a ramp signal whose voltage level corresponds to the amount of the electric current flowing to the inductor and; a reset signal supply circuit for supplying to the driving signal supply circuit a reset signal by which a supply of the driving signal is stopped in response to the ramp signal. The ramp signal generation circuit generates the ramp signal whose slop corresponds to a voltage difference between an output voltage generated on the output terminal and an input voltage supplied to the input terminal.

According to the DC-DC converter of the present invention, the slope compensation circuit generates the slope compensation voltage (ramp signal) having a slope proportional to a difference between output and input voltages. An optimal slope compensation can be performed without providing an external input terminal even when the dynamic range of the power output is widened.

### BRIEF DESCRIPTION OF THE DRAWINGS

FIG. 1 is an equivalent circuit diagram of a step-up DC-DC converter that is an embodiment of the present invention;

FIG. 2 is a timing chart showing a basic operation of the step-up DC-DC converter which is the embodiment of the present invention;

FIG. 3 is operation waveforms of each part showing a controlled slope of a slope compensation voltage by the slope compensation circuit which is included by the circuit of FIG. 1;

FIG. 4 is an equivalent circuit diagram of a step-up DC-DC converter which is another embodiment of the present invention; and

FIG. 5 is an equivalent circuit diagram of a step-up DC-DC converter which is a further embodiment of the present invention.

### DETAILED DESCRIPTION OF THE INVENTION

Some embodiments of the present invention are described below with reference to the accompanying drawings. In the following figures, substantially same or equivalent components and parts are denoted by the same reference numerals.

### First Embodiment

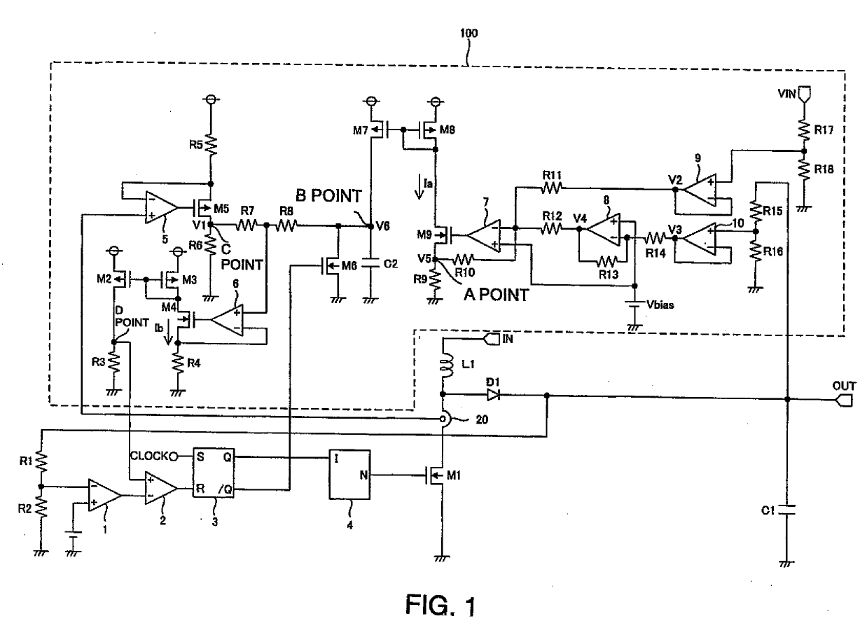

FIG. 1 is an equivalent circuit diagram illustrating a configuration of a current-mode control DC-DC converter according to a first embodiment of the present invention. The configuration of the DC-DC converter according to the embodiment will be now described below.

The DC-DC converter of the first embodiment is a step-up DC-DC converter with an asynchronous rectification for increasing an input voltage VIN applied on an input terminal IN to a given voltage, and for generating the increased input voltage from an output terminal OUT. A coil L1 is connected to the input terminal. An output transistor M1 constituted by, for example, an NMOS transistor is connected in series to the coil L1 via a current detection circuit 20. The output transistor M1 is driven in response to a driving signal supplied by a driver circuit 4 described later. The output transistor M1 thus constitutes a switching circuit of the present invention, for on-off controlling an electric current flowing through the coil L1. An anode of the diode D1 is connected to a node between the coil L1 and the current detection circuit 20. A cathode of the diode D1 is connected to the output terminal OUT. A condenser Cl for smoothing the output voltage is connected between the output terminal OUT and a ground line.

An output voltage Vout appearing on the output terminal OUT is connected to division resistances R1 and R2 which are connected in series to each other. A feedback voltage derived from a connected middle point of these division resistances is connected to an inverting input terminal of a differential amplifier 1. A given reference voltage Vref is applied on a non-inverting input terminal of the differential amplifier 1. The differential amplifier 1 generates an output voltage corresponding to a difference between the reference voltage Vref and the feedback voltage. The differential amplifier 1 also supplies this output voltage to an inverting input terminal of a PWM comparator 2. A slope compensation voltage Vs (ramp signal) supplied by a slope compensation circuit 100 corresponding to the ramp signal generation means of the present invention is applied on a non-inverting input terminal of the PWM comparator 2. When a voltage level of the slope compensation voltage Vs is above a level of the output voltage of the differential amplifier 1, the PWM comparator 2 generates a high level output signal. The output signal of the PWM comparator 2 is supplied to a reset input terminal of a RS flip flop 3. A clock pulse at a fixed frequency is supplied to a set input terminal of the RS flip flop 3 by an oscillator which is not illustrated in FIG. 1. The RS flip flop 3 is set at a leading edge of the clock pulse, thus generating a high level voltage from an output terminal Q and maintaining its state until a reset input is applied from the PWM comparator. When the reset input is applied from the PWM comparator 2, the RS flip flop 3 keeps a low level state up to a leading edge of a subsequent clock pulse. The output Q of the RS flip flop 3 is supplied to an input terminal I of the driver circuit 4. The driver circuit 4 generates an output voltage, which corresponds to the voltage level applied to the input terminal I thereof, to an output terminal N as a drive voltage. The output terminal N of the driver circuit 4 is connected to a gate of the output transistor M1. The output transistor M1 is on-off controlled in response to the drive voltage supplied from the driver circuit 4. The RS flip flop 3 also generates from the other output terminal /Q a signal whose phase is inverse to that of the output terminal Q and supplies the signal to a gate of a transistor M6 of the slope compensation circuit 100 described later.

When the output transistor M1 is rapidly changed from an on-state into an off-state in response to the drive voltage supplied from the driver circuit 4, a voltage is generated at both ends of the coil L1. This voltage is superimposed on the input voltage VIN so as to conduct a diode, and is transmitted to the output terminal OUT. At a normal operation, such an operation is repeated at a frequency of the clock pulse. An increased output voltage Vout, which is Vout>Vin, is generated from the output terminal OUT.

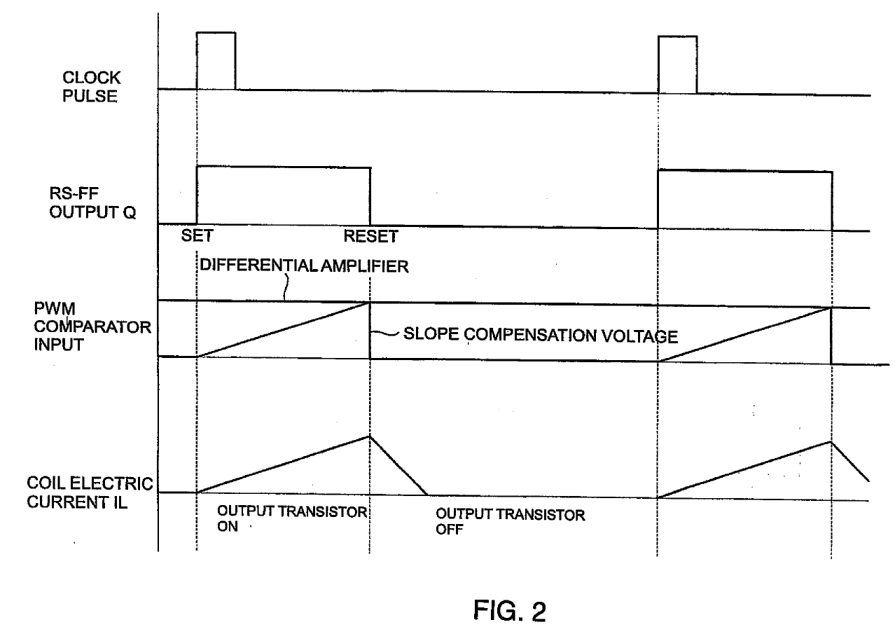

Before describing the slope compensation circuit 100, a fundamental operation of a DC-DC converter of the present invention will be now described with reference to FIG. 2. FIG. 2 shows operation waveforms of each part in a normal operation mode of the DC-DC converter of the present invention. A clock pulse is applied on a RS flip flop 3 at a time of a set input, and thus the RS flip flop 3 is set at a leading edge of the clock pulse. When the RS flip flop 3 is changed into a set state, the RS flip flop 3 generates a high level output voltage to the output terminal Q, and then supplies this high level output voltage to the drive circuit 4. The RS flip flop 3 also generates a low level output voltage to the output terminal /Q, and then supplies this low level output voltage to the gate of the transistor M6 in the slope compensation circuit 100. The transistor M6 maintains the off-state in response to the low level output voltage during the RS flip flop is set. The drive circuit 4 generates a high level drive voltage on the basis of the high level output voltage supplied from the RS flip flop 3, and then supplies the high level drive voltage to the gate of output transistor M1. The transistor M1 is turned on in response to the high level drive voltage, and a coil electric current IL flows to the coil L1. The coil electric current IL increases at a constant rate.

A voltage generated on the output terminal OUT of the DC-DC converter is applied on the division resistances R1 and R2 which are connected in the series to each other. A feedback voltage derived from the connected middle point of the division resistances is applied on the inverting input terminal of the differential amplifier 1. The differential amplifier 1 generates an output signal corresponding to a difference between the feedback voltage and the reference voltage Vref, and then supplies this output signal to the inverting input terminal of the PWM comparator 2. An output voltage of the differential amplifier 1 is maintained at a substantially constant voltage level in the steady state. On the other hand, the slope compensation circuit 100 supplies to a non-inverting input terminal of the PWM comparator 2 a slope compensation voltage Vs of a sawtooth waveform whose voltage level increases at a constant rate from the time when the RS flip-flop 3 is set. The PWM comparator 2 compares these two input voltages. If a voltage level of the slope compensation voltage Vs is above a voltage level of the output voltage of the differential amplifier 1, the PWM comparator 2 generates a high level output voltage, and then supplies this high level output voltage to the reset input of the RS flip flop 3. Thus, the RS flip flop 3 is reset, and then the output signal generated from the output terminal Q is changed to a low level. As a result, the transistor M1 is turned off. When the output transistor M1 is changed to an off-state, the coil electric current IL decreases at a constant rate. Since the RS flip flop 3 is resets, the transistor M6 is turned on, and thus the slope compensation voltage Vs descends steeply. And, the RS flip flop 3 is set again at a leading edge of a subsequent clock pulse. The repeated operation maintains the output voltage Vout of the DC-DC converter at a constant voltage level. As can be seen in the above description, a timing that the output transistor M1 is turned off is controlled by a slope of the slope compensation voltage Vs.

The slope compensation circuit 100 will be now described below. The current detection circuit 20 is provided between the coil L1 and the transistor M1 and on a current path through which the coil electric current IL flows. The current detection circuit 20 generates a current detection signal having a voltage level corresponding to the coil electric current IL, and then supplies this current detection signal to a non-inverting input terminal of an operational amplifier 5. An output terminal of the operational amplifier 5 is connected to a gate of a PMOS transistor M5. A non-inverting input terminal is connected to a source of the PMOS transistor MS. The source of the PMOS transistor MS is connected to a resistance RS connected to a power supply line. A drain of the PMOS transistor MS is connected to a resistance R6 connected to a ground line. An amplifier is constituted with the operational amplifier 5, the transistor M5, and the resistances R5 and R6. The current detection signal supplied to the operational amplifier 5 is made to be R5/R6 times, thus appearing this voltage as a voltage VI at the C point of the figure.

An input voltage VIN of the DC-DC converter is divided by division resistances R17 and R18 which are connected in series to each other. An electrical potential at a connected middle point between the division resistances R17 and R18 is supplied to a non-inverting input terminal of a differential amplifier 9. An inverting input terminal of the differential amplifier 9 is connected to an output terminal thereof, thus a voltage follower is constituted. That is, a divided voltage of the input voltage VIN supplied to the differential amplification circuit 9 is generated from the output terminal of the differential amplifier 9 as an output voltage V2, with the divided voltage of the input voltage VIN being maintained in its voltage level.

Similarly, an output voltage Vout appearing on the output terminal OUT of the DC-DC converter is divided by division resistances R15 and R16 which are connected in series to each other. An electrical potential at a connected middle point between the division resistances R15 and R16 is supplied to a non-inverting input terminal of a differential amplifier 10. An inverting input terminal of the differential amplifier 10 is connected to an output terminal thereof, thus a voltage follower is constituted. That is, a divided voltage of the output voltage Vout supplied to the differential amplification circuit 10 is generated from an output terminal of the differential amplifier 10 as an output voltage V3 with the divided voltage of the output voltage Vout being maintained in its voltage level. It is configured that a division ratio of the division resistance R17 to the division resistance R18 is substantially equal to a division ratio of the division resistance R15 to the division resistance R16.

A bias voltage Vbias is applied on a non-inverting input terminal of an operational amplifier 8 which terminal is connected to a bias power supply. The output terminal of the differential amplifier 10 is connected to an inverting input terminal of the operational amplifier 8 via a resistance R14. A resistance R13 is connected between an output terminal and the inverting input terminal of the operational amplifiers 8. That is, a reversing amplifier is constituted with the operational amplifier 8, the resistances R13, R14, and the bias power supply. An amplification degree of the operational amplifier 8 is −1 if the resistances R13=R14. In this case, the operational amplifier 8 inverses voltage V3 supplied via the resistance R14 based on the bias voltage Vbias. The operational amplifier 8 outputs the inversed voltage V3 as an output voltage V4.

The voltages V2 and V4 are supplied to an inverting input terminal of an operational amplifier 7 via resistances R11 and R12, respectively. The bias voltage Vbias is applied on a non-inverting input terminal of the operational amplifier 7 connected to the bias power supply. An output terminal of operational amplifier 7 is connected to a gate of an NMOS transistor M9. A resistance R9 is connected between a source of the NMOS transistors M9 and a ground line. A resistance R10 is connected between the source (point A) of NMOS transistor M9 and the inverting input terminal of the operational amplifier 7. A drain of the NMOS transistor M9 is connected to a drain of a PMOS transistor M8. A gate and drain of the PMOS transistor M8 are short-circuited. A source of the PMOS transistor M8 is connected to a power supply line. An adding circuit is constituted with the operational amplifier 7, the transistor M9, the resistances R9, R10, R11, and R12. If all values of the resistances R10, R11, and R12 are equally configured, the operational amplifier 7 drives the NMOS transistor M9 so that an inversion additive value of the voltages V2 and V4 appears on the point A of FIG. 1. That is, the operational amplifier 7 drives the NMOS transistor M9 so that a voltage V5 proportional to a difference (Vout−Vin) between the input voltage VIN and the output voltage Vout of the DC-DC converter is generated on the point A. Therefore, a slope control electric current Ia proportional to the difference (Vout−Vin) can flow to the NMOS transistor M9. A gate of a PMOS transistor M7 is connected to the gate of the PMOS transistor M8. A source of the PMOS transistor M7 is connected to the power supply line. A drain of the PMOS transistor M7 is connected to a condenser C2 connected to the ground line. A current mirror circuit is constituted by the transistors M7 and M8. The transistor M7 generates a mirror electric current of the slope control electric current Ia, so that the condenser C2 is electrically charged. Since the condenser C2 is electrically charged with the slope control electric current Ia, a slope control voltage V6, which increases with a slope proportional to a current value of the slope control electric current Ia, is generated on a point B of FIG. 1. The NMOS transistor M6 is connected in parallel to the condenser C2. The gate of the NMOS transistor M6 is connected to the output terminal /Q of the RS flip flop 3. The NMOS transistor M6 is on/off operated in response to the output voltage of the RS flip flop 3. The NMOS transistor M6 is turned on during the reset period, and thus discharges the electric charge electrically charged in the condenser C2.

The slope control voltage V6 is supplied to a non-inverting input terminal of an operational amplifier 6 via a resistance R8. An amplification signal V1 of the current detection signal at the point C of FIG. 1 is also supplied to the non-inverting input terminal of the operational amplifier 6 via a resistance R7. An output terminal of the operational amplifier 6 is connected to a gate of an NMOS transistor M4. An inverting input terminal of the operational amplifier 6 is connected to a source of the NMOS transistor M4. The source of the NMOS transistor M4 is connected to a resistance R4 connected to the ground line. A drain of the NMOS transistor M4 is connected to a drain of a PMOS transistor M3. The gate and drain of PMOS transistor M3 are short-circuited, and the source of PMOS transistor M3 is connected to the power supply line. A voltage-current translate circuit is constituted with the NMOS transistor M4, the operational amplifier 6, the resistances R4, R7, and R8. The NMOS transistor M4 generates a correction slope control electric current I2 proportional to a voltage in which an amplification signal V1 of the current detection signal at the point C and the slope control voltage V6 at the point B are added. A current mirror circuit is constituted with the PMOS transistors M2 and M3. The PMOS transistor M2 supplies a mirror electric current of the correction slope control electric current I2 to a resistance R3, so that a slope compensation voltage Vs proportional to the correction slope control electric current I2 appears on a node (the point D) between the resistance R3 and the PMOS transistor M2. The slope compensation voltage Vs generated on the point D of FIG. 1 is connected to the inverting input terminal of the PWM comparator 2.

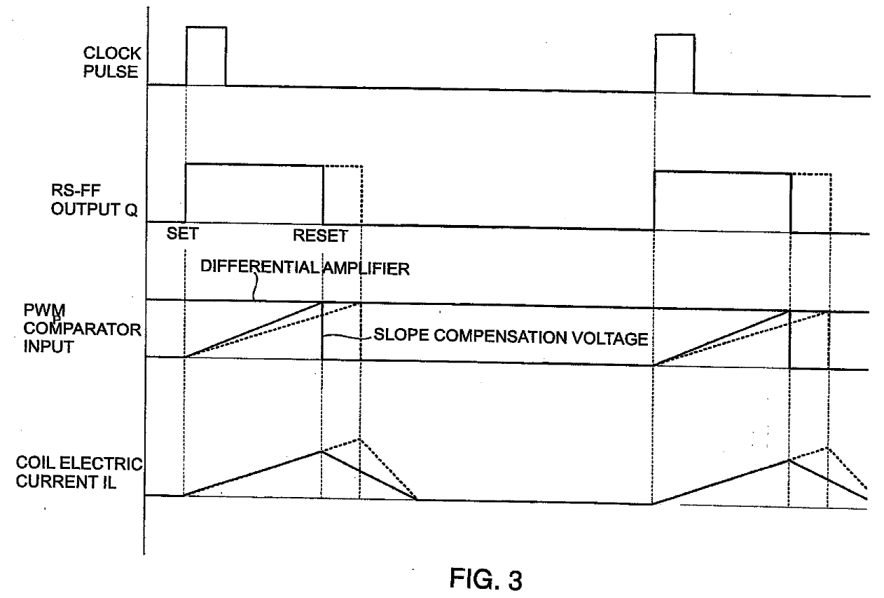

An operation of the slope compensation circuit 100 will now be described with reference to FIG. 3. The slope compensation circuit 100 generates an optimal slope compensation voltage Vs in response to the input/output voltages. The solid line of FIG. 3 shows a case that a difference (Vout−Vin) between the output voltage Vout and the input voltage VIN of the DC-DC converter is large. The broken line of FIG. 3 shows a case that the difference (Vout−Vin) is small. The input voltage VIN and the output voltage Vout of the DC-DC converter are divided by the division resistances R17, R18, and R15, R16, respectively. The input voltage VIN and the output voltage Vout are generated via a buffer circuit having operational amplifiers 9, 10 as voltages V1 and V2, respectively. The division voltage V2 of the output voltage Vout is inversed by a inversing amplifier including the operational amplifier 8. The adding circuit including operational amplifier 7 generates a slope control electric current Ia proportional to a voltage in which the division voltage V1 of the input voltage VIN and the Inversed division voltage V3 of the output voltage Vout are added. That is, the slope control electric current Ia is proportional to the difference between the output current Vout and the input voltage VIN of the DC-DC converter. The PMOS transistor M7 generates a mirror electric current of this slope control electric current Ia, and thus electrically charges the condenser C2. Thus, the PMOS transistor M7 generates a slope control voltage V6 at the point B which increases with a constant slope. The slope control voltage V6 is added with the amplification voltage VI of the current detection signal generated at the point C of FIG. 1 by the voltage-current translate circuit including the operational amplifier 6. The slope control voltage V6 is finally generated as a slope compensation voltage Vs. A value proportional to the slope control voltage V6 is added to the slope of the slope compensation voltage Vs by which a timing of intercepting the coil electric current IL is determined. That is, the slope of the slope compensation voltage Vs is proportional to the slope control electric current Ia. Since the slope control electric current Ia is proportional to the difference between the output voltage Vout and the input voltage VIN of the DC-DC converter, a slope proportional to the difference (Vout−VIN) is added to the slope of the slope compensation voltage Vs.

If the difference (Vout−VIN) between the output voltage Vout and the input voltage VIN of the DC-DC converter is large, the slope of the slope compensation voltage increases, and thus an on-off period of the output transistor M1 is shortened. If the difference between output voltage Vout and input voltage VIN is large, the slope of the decreasing coil electric current IL decreases so as to be gradual after the output transistor M1 is turned off. Although the time when the coil electric current IL is completely zero is prolonged, by increasing the slope of the slope compensation voltage Vs and shortening a off-timing of the output transistor M1, the energizing period can be suppressed to be equal to or less than 50% of the clock cycle. The sub-harmonic phenomenon is thus effectively prevented.

If a difference (Vout−VIN) between the output voltage Vout and the input voltage VIN of the DC-DC converter is small, the slope of the slope compensation voltage decreases to be gradual. Although the period from turning on output transistor M1 to turning off comparatively becomes long, if a difference between the output voltage Vout and the input voltage VIN is small, the slope of the coil electric current ratio when the coil electric current IL descends increases to be steep comparatively after the output transistor M1 is turned off. Therefore, the ratio of a period of applying a voltage for the clock cycle can be suppressed to be equal to or less than 50%. The generation of the sub-harmonic phenomenon can be prevented.

As can be seen from the above description, according to the DC-DC converter of the present invention, the slope of the slope compensation voltage changes in response to the difference between the output and input voltages of DC-DC converter. Thus, it is applicable for a step-up DC-DC converter. An optimal compensation of the'slope corresponding to the difference between input/output voltages is possible without providing an external input terminal. Therefore, it is possible to constitute a DC-DC converter operating in a wide dynamic range. In the circuit of the first embodiment, it is possible to basically set the slope of the slope compensation voltage by configuring values of the condenser C2 and the resistance R9. For instance., the slope of a desired slope compensation voltage can be obtained by setting these constants according to the inductance of coil L1. Although the first embodiment is described as an example of the case of an application of a DC-DC converter of the asynchronous rectification method, Ii is possible to apply to a DC-DC converter of the synchronous rectification method. Although the first embodiment is described as an example of the case of an application of a DC-DC converter of the non-insulated type, it is also possible to apply to the insulated.

### Second Embodiment

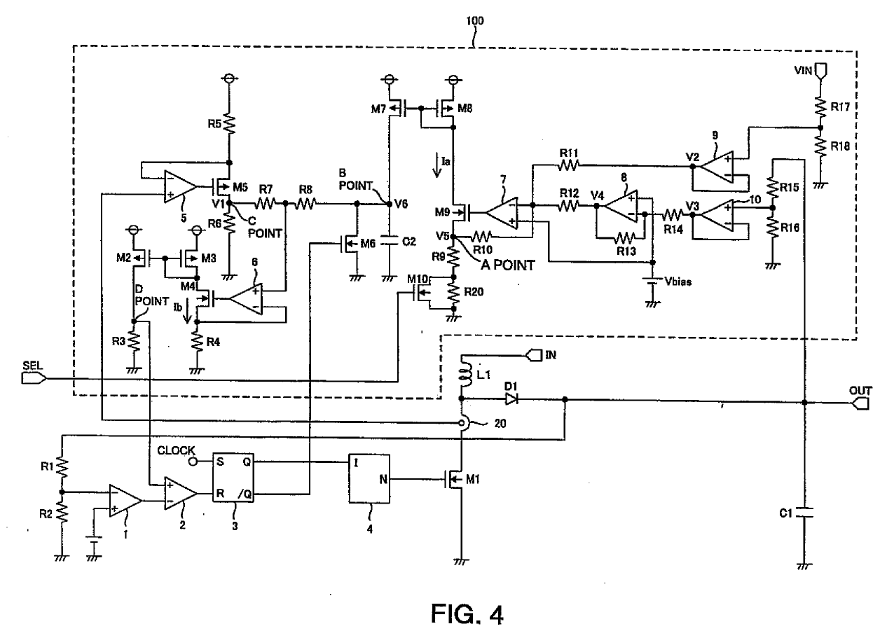

FIG. 4 shows an equivalent circuit diagram of a DC-DC converter which is a second embodiment of the present invention. Although a basic constitution of the DC-DC converter of the second embodiment is similar to that of the first embodiment, it is constituted that a resistance between a point A of FIG. 4 for determining a slope control electric current Ia and grand potential can be changed. Specifically, a resistance R20 and an NMOS transistor M10 are additionally provided in the circuit of the first embodiment. The resistance R20 has one end connected to a grand line and the other end connected in series to a resistance R9. The NMOS transistor M10 is connected in parallel to the resistance R20. A gate of the NMOS transistor M10, to which a gate voltage is applied via an external input terminal SEL, is connected to the external input terminal SEL. The NMOS transistor M10 can be externally on-off controlled via the external input terminal SEL. In such a circuit constitution, a slope compensation voltage can be changed in slope by an external input. A high level control signal applied on the external input terminal SEL turns on the NMOS transistor M10. Since a resistance between the point A and the grand line is changed to be small, the slope compensation electric current Ia increases to be high, so that the slope of the slope compensation voltage Vs is increased. A low level control signal applied on the external input terminal SEL turns off the NMOS transistor M10. Since the resistance between the point A and the grand line is changed to be large, the slope compensation electric current Ia decreases, so that the slope of the slope compensation voltage Vs is changed to be gradual.

According to the DC-DC converter of the second embodiment, it is constituted that the resistance between the point A and the grand line can be switched by an external input, the slope of the slope compensation voltage Vs can be switched externally. For instance, even when an inductance of coil L1 is required to be changed, the slope of the slope compensation voltage Vs can be changed depending on the inductance of the coil L1, thus improving freedom of design of the inductance.

The second embodiment, where the resistance between the point A and grand line can be changed by the external input, is constituted. By switching a capacity of the condenser C2 to which a charge electric current of the slope compensation electric current Ia is supplied according to an external input, the slope of the slope compensation voltage Vs can be changed. By switching according to an external input a mirror ratio of the transistor M7 for supplying a mirror electric current of slope compensation electric current Ia, the slope of the slope compensation voltage Vs can be also changed.

### Third Embodiment

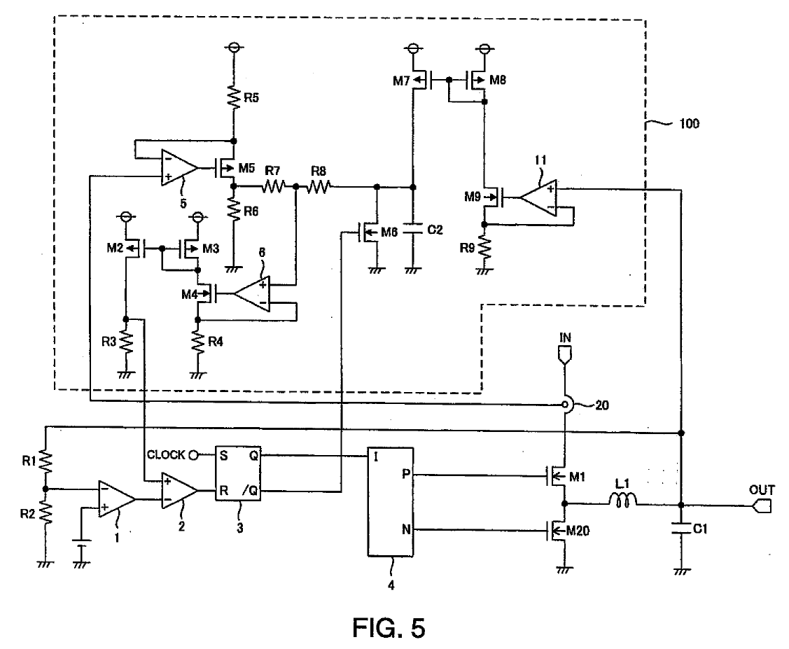

FIG. 5 shows an equivalent circuit diagram of a DC-DC converter which a third embodiment of the present invention. The DC-DC converter of the third embodiment is a step-down DC-DC converter with a synchronous rectification. The step-down DC-DC converter with a synchronous rectification descends an input voltage VIN applied on an input terminal IN to be a given voltage, and generates the given voltage from an output terminal OUT. The input terminal is connected to an output transistor M1 via a current detection circuit 20. An NMOS transistor M20, which functions as a synchronous rectification device, is connected in series to the output transistor M1. A gate of the output transistor M1 is connected to an output terminal P of a driver circuit 4. A gate of the NMOS transistor M20 is connected to an output terminal N of the driver circuit 4. A source of the NMOS transistor M20 is grounded. A coil L1 is connected to a node between the output transistor M1 and the NMOS transistor M20, and also connected to the output terminal OUT. A condenser C1 for smoothing the output voltage is connected between the output terminal OUT and a ground line. Drive voltages whose phases are inversed to each other are supplied by the drive circuit 4 to the output transistor M1 and the NMOS transistor M20, respectively. A constant DC voltage is generated from the output terminal OUT by alternately driving the output transistor M1 and the NMOS transistor M20 in response to a clock pulse.

The step-up DC-DC converter generates a slope control voltage V6 by using only an output voltage Vout generated on the output terminal OUT. The output voltage Vout is connected to a non-inverting input terminal of an operational amplifier 11. An output terminal of the operational amplifier 11 is connected to a gate of an NMOS transistor M9. An inverting input terminal of the operational amplifier 11 is connected to a source of the NMOS transistor M9. A source of the NMOS transistor M9 is connected to a resistance R9 connected to the ground line. The gate and drain of the NMOS transistor M9 are short-circuited. The source of NMOS transistor M9 is connected to a drain of a PMOS transistor M8 connected to a power supply line. A voltage-current translate circuit is constituted with the NMOS transistor M9, the resistance R9, and the operational amplifier 11. A slope control electric current Ia proportional to the output voltage Vout received by the operation amplifier 11 flows to the NMOS transistor M9. A current mirror circuit is constituted by the PMOS transistor M7 and M8. The PMOS transistor M7 generates a mirror electric current of the slope control electric current Ia by which a condenser C2 is electrically charged. Since the condenser C2 is electrically charged with the slope control electric current Ia, A slope control voltage V6, which increases with a slope proportional to a current value of the slope control electric current Ia, appears on the point B of FIG. 5. An NMOS transistor M6 is connected in parallel to the condenser C2. A gate of the NMOS transistor M6 is connected to an output terminal /Q of a RS flip flop 3. The NMOS transistor M6 is on-off operated in response to an output voltage of the RS flip flop 3. The NMOS transistor M6 is turned on for a reset period, and thus the NMOS transistor M6 electrically discharges the electric charge of the condenser C2. The slope control voltage V6 is added with an amplification voltage V1 of a current detection signal generated on the point C of FIG. 5 by a voltage-current translate circuit including an operational amplifier 6. And then, the slope control voltage V6 is finally generated as a slope compensation voltage Vs. In similar with the first embodiment, the slope compensation voltage Vs is connected to an inverting input terminal of a PWM comparator 2 by which the slope compensation voltage Vs is compared with an output voltage of a differential amplifier 1. The slope compensation voltage Vs determines a reset timing for the RS flip flop 3. Since constitution and the operation are similar to those of the first embodiment expect of the above description, the explanation is omitted.

The step-up DC-DC converter generates a slope compensation voltage Vs whose slope is proportional to an output voltage Vout generated on an output terminal OUT. The PWM comparator 2 compares the output voltage of the differential amplifier 1 with the slope compensation voltage VS, and determines a reset timing. A PWM controlling in response to a change in the output voltage Vout is thus possible without an external input terminal, so that the sub-harmonic phenomenon is effectively prevented.

This application is based on Japanese Patent Application No. 2007-328558 which is herein incorporated be reference.

What is claimed is:

1. A DC-DC converter comprising:
a switching circuit connected to an inductor connected between input and output terminals, for turning on/off an electric current flowing to said inductor in response to a driving signal;
a driving signal supply circuit for supplying said driving signal to said switching circuit;
a ramp signal generation circuit for generating a ramp signal whose voltage level corresponds to the amount of the electric current flowing to said inductor and;
a reset signal supply circuit for supplying to said driving signal supply circuit a reset signal by which a supply of said driving signal is stopped in response to said ramp signal;
wherein said ramp signal generation circuit generates said ramp signal whose slop corresponds to a voltage difference between an output voltage generated on said output terminal and an input voltage supplied to said input terminal.

2. A DC-DC converter according to claim 1,
wherein said ramp signal generation circuit comprises
a capacitor; and
a slope control electric current generation circuit for generating a slope control electric current corresponding to a voltage which is equal to a subtraction of a voltage corresponding to said input voltage and a voltage corresponding to said output voltage, said slope control electric current generation circuit electrically charging said capacitor with said slope control electric current,
wherein said ramp signal generation circuit generates said ramp signal whose slope corresponds to a charging voltage of said capacitor.

3. A DC-DC converter according to claim 2 further comprising a slope control electric current switching mean for switching a magnitude of said slope control electric current based on an external input signal.

4. A DC-DC converter according to claim 2,
wherein said ramp signal generation circuit generates as said ramp signal a voltage corresponding to a voltage which is equal to an addition of a charging voltage of said capacitor and a voltage corresponding to the amount of the current flowing to said inductor.
